(19) United States
(12) Patent Application Publication
(10) Pub. No.: US 2008/0071555 A1
(43) Pub. Date: Mar. 20, 2008

(54) Application solution proposal engine

(76) Inventors: Juergen Sattler, Wiesloch (DE); Joachim Gaffga, Wiesloch (DE); Robert Viehmann, Waghausl (DE); Frank Markert, Gossostheim (DE); Werner Wolf, Wiesloch (DE)

Correspondence Address: SCHWEGMAN, LUNDBERG & WOESSNER/SAP, P.O. BOX 2938, MINNEAPOLIS, MN, 55402, US

(21) Appl. No.: 11/512,518

(22) Filed: Aug. 29, 2006

(51) Int. Cl. G06Q 10/00

(52) U.S. Cl. 705/1

(57) ABSTRACT

The present subject mater relates to computer application solutions and, more particularly, an application solution proposal engine. The various embodiments herein provide systems, methods, and software to receive customer information including information detailing customer data processing preferences, process the customer information to identify portions of an application related to the customer data processing preferences, and generate one or more application proposals as a function of the identified portions of the application. These and other embodiments may rapidly provide an application solution proposal and ancillary information to a customer.

### TECHNICAL FIELD

The present subject mater relates to computer application solutions and, more particularly, an application solution proposal engine.

### BACKGROUND INFORMATION

Many large-scale computer applications are rather amorphous and can be configured in many different ways to provide many different types of functionality. Some such computer applications include enterprise resource planning (“ERP”) applications.

Determining how to configure such large-scale computer applications is commonly a difficult task. Further, when a company selling such applications needs to make a proposal, the task is typically quite involved. Many application providers simplify the proposal process by providing application proposals that are very general and are not tailored to a specific customer. As a result, customers receiving the proposals may end up paying for application functionality that will not be used. Further, customers may not be fully apprised of the efforts and costs needed to implement the application beyond an initial installation.

Thus, when purchasing large-scale computer applications, the environment is not customer friendly and has a reputation of being “buyer beware.”

### BRIEF DESCRIPTION OF THE DRAWINGS

FIG. 1 is a block diagram of a system according to an example embodiment.

FIG. 2A is a block diagram of a system according to an example embodiment.

FIG. 2B is a block diagram of a system according to an example embodiment.

FIG. 3 is a block diagram of a system according to an example embodiment.

FIG. 4 is a flow diagram of a method according to an example embodiment.

FIG. 5 is a block diagram of a computing system according to an example embodiment.

### DETAILED DESCRIPTION

To make the purchasing environment of large-scale computer applications more customer friendly, some embodiments of the following subject matter provide more specific application solution proposals. Some such embodiments further provide cost estimates, project plans, timelines, and other information that can be useful to customers in making purchasing decisions related to large-scale computer applications, such as enterprise resource planning (“ERP”) applications.

In some such embodiments, customer profile information is received and processed to generate an application solution proposal. An application solution proposal may identify an application, functionality the application will provide, additional functionality and flexibility the application can provide, a data migration plan, and other information useful to the customer in making a purchasing decision.

In some embodiments, a cost estimate is also provided. The cost estimate may provide details of various elements associated with purchasing, installing, and configuring an application. The cost estimate may provide an initial cost for purchasing the application and/or a periodic license fee. The cost estimate may also include a cost for one or more support options a customer may purchase or subscribe to. Additionally, the cost estimate may provide a cost estimate of third-party contractors need to implement the application. Other costs may also be included with the cost estimate.

In some embodiments, a project plan may also be provided that details required and/or optional project steps to implement the application of the application proposal. These and other embodiments are described in greater detail below.

In the following detailed description, reference is made to the accompanying drawings that form a part hereof, and in which is shown by way of illustration specific embodiments in which the inventive subject matter may be practiced. These embodiments are described in sufficient detail to enable those skilled in the art to practice them, and it is to be understood that other embodiments may be utilized and that structural, logical, and electrical changes may be made without departing from the scope of the inventive subject matter. Such embodiments of the inventive subject matter may be referred to, individually and/or collectively, herein by the term “invention” merely for convenience and without intending to voluntarily limit the scope of this application to any single invention or inventive concept if more than one is in fact disclosed.

The following description is, therefore, not to be taken in a limited sense, and the scope of the inventive subject matter is defined by the appended claims.

The functions or algorithms described herein are implemented in hardware, software or a combination of software and hardware in one embodiment. The software comprises computer executable instructions stored on computer readable media such as memory or other type of storage devices. The term “computer readable media” is also used to represent carrier waves on which the software is transmitted. Further, such functions correspond to modules, which are software, hardware, firmware, or any combination thereof. Multiple functions are performed in one or more modules as desired, and the embodiments described are merely examples. The software is executed on a digital signal processor, ASIC, microprocessor, or other type of processor operating on a system, such as a personal computer, server, a router, or other device capable of processing data including network interconnection devices.

Some embodiments implement the functions in two or more specific interconnected hardware modules or devices with related control and data signals communicated between and through the modules, or as portions of an application-specific integrated circuit. Thus, the exemplary process flow is applicable to software, firmware, and hardware implementations.

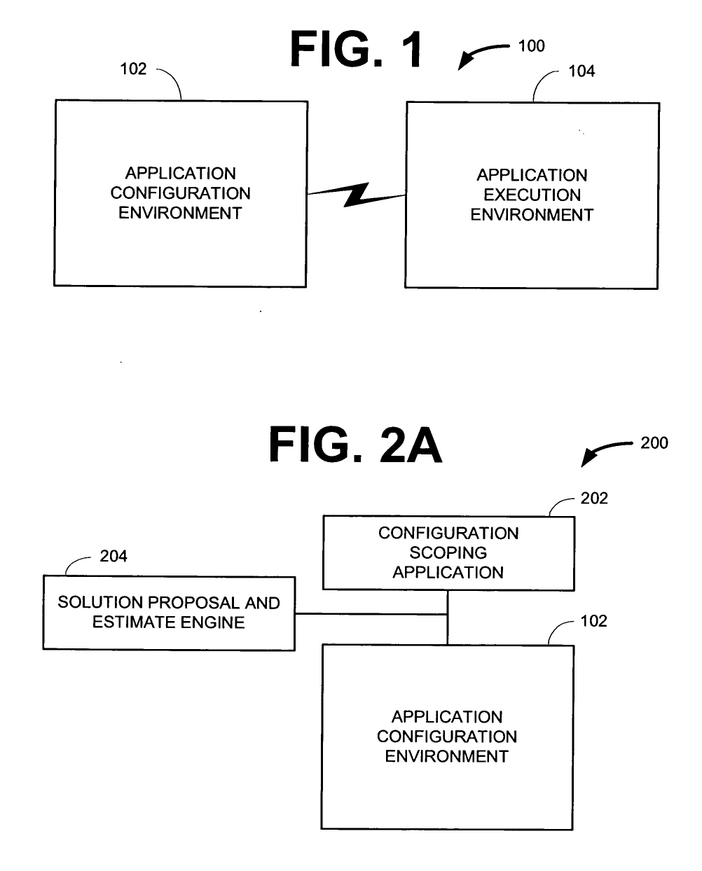

FIG. 1 is a block diagram of a system 100 according to an example embodiment. The system 100 includes an application configuration environment 102 and an application execution environment 104.

The application configuration environment 102 is a system 100 environment within which an application can be configured. However, the application will, or does, execute within the application execution environment 104. In some embodiments, this arrangement of the application configuration environment 102 and the application execution environment 104 separates the configuration of an application from the environment within which it executes. When an application configuration has been established, all or part of the configuration can then be deployed to the application execution environment 104. This deployment can occur to one or more separate instances of the application in the application execution environment 104. Although only a single application execution environment 104 is illustrated, multiple application execution environments 104 can exist, and the deployment can be made to one or more of the multiple application execution environments 104.

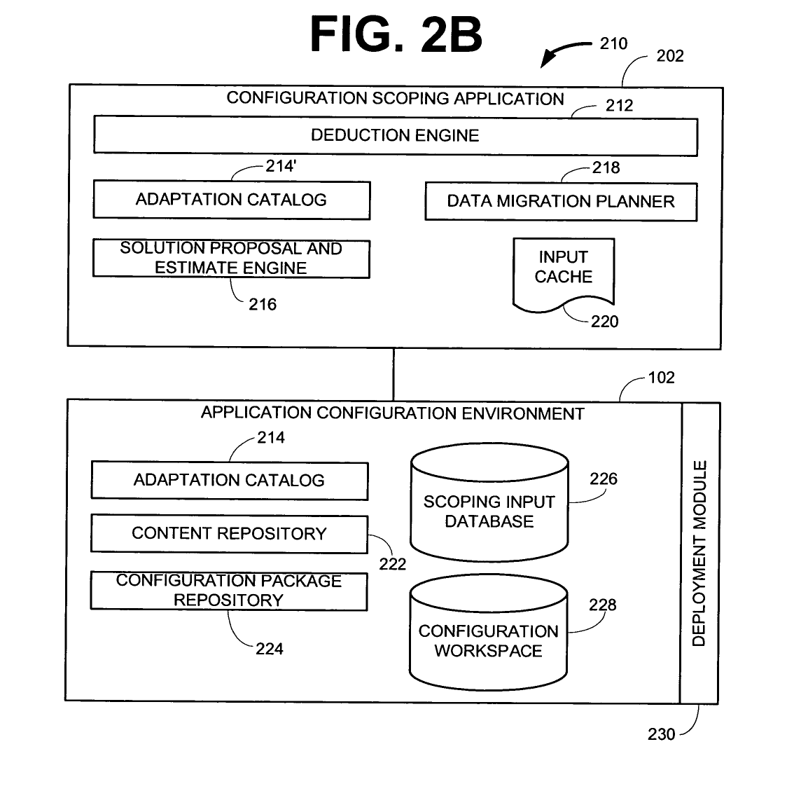

FIG. 2A is a block diagram of a system 200 according to an example embodiment. The system 200 includes a configuration scoping application 202, a solution proposal and estimate engine 204, and the application configuration environment 102.

The configuration scoping application 202 typically is a software tool that executes on a computing device, such as a portable computer, on a same computing device within which the application configuration environment 102 exists, or on another computing device that can be communicatively coupled to the application configuration environment 102.

The configuration scoping application 202, when executed, typically presents a set of scoping questions to a user. The scoping questions are linked to one of many adaptation catalog entries. The adaptation catalog entries include a representation of all of the solution capabilities of an application to be configured, and eventually executed. In some embodiments, the solution capabilities are hierarchically divided into areas, packages, topics, and options. There may be multiple areas and each area may have multiple packages. Each package may have multiple topics and each topic may have multiple options.

In some embodiments, such as in an example embodiment where the application to be configured is an ERP application, the adaptation catalog may provide in the area Sales, a package Customer Order Management that contains the topics Sales Order Quote, Sales Order, Sales Order Analysis, and others. On that level, one or more options typically exist such as Approval Processing.

In the configuration scoping application 202, as stated above, each scoping question may be linked to an adaptation catalog entry. An adaptation catalog entry further includes a rule. These rules typically model dependencies between the areas, packages, topics, and options and corresponding solution capabilities of the application. A rule may specify required inclusion or exclusion of other areas, packages, topics, or options, or may require specification of further areas, packages, topics, or options. A rule may also specify a recommendation or default area, package, topic, or option.

For example, a first example scoping question, “What is the primary focus of your business?” may have three possible answers including “Sales,” “Service,” and “Logistics.” Such a first scoping question typically is aimed at identifying an area of business in which the application is going to be used. Answering “Sales” typically tells the configuration scoping application 202 that the area is “Sales” and a rule tied to the adaptation catalog entry for “Sales” specifies dependencies with packages, topics, and options and the corresponding solution capabilities of the application necessary or optional in using the application in a sales business. Such a rule can also specify that other packages, topics, and options and the corresponding solution capabilities are excluded.

Thus, when a user answers scoping questions, the configuration of the application is being performed. Further, when a question is answered that is associated with an adaptation catalog entry having a rule that excludes another area, package, topic, or option, that rule may be applied to eliminate questions from consideration. Conversely, when a question is answered that is associated with an adaptation catalog entry having a rule that requires another area, package, topic, or option, that same rule may be applied to determine a next question, or group of questions, to ask a user. However, in the event that a question is not answered that is linked to a rule providing defaults, the question may be skipped without adversely affecting the application configuration.

The solution proposal and estimate engine 204 typically executes to provide output after answers to the scoping questions have been received. The output generated by the solution proposal and estimate engine 204 may include one or more of an application proposal, a project roadmap to implement and configure the proposed application, and a cost estimate.

In some embodiments, the application proposal may include one or more proposed applications selected as a function of the scoping question answers. An application of an application proposal is typically selected when the application meets at least some customer needs as identified from the scoping question answers. The application proposal may further include a listing of functionality that meets identified needs of a customer and other functionality that is available. In yet further embodiments, the application proposal may further include a hardware requirement listing specifying minimum hardware requirements for implementing the application of an application proposal.

In some embodiments, the project roadmap includes a listing of tasks that are needed to implement and configure a proposed application. The tasks within a project roadmap may include a timeline for performing the tasks. In some such embodiments, the project roadmap may include a time estimate to implement the application and bring the application online in a test or production environment.

In some embodiments, the cost estimate includes one or more cost estimates to implement the application of an application proposal. Some such cost may include a cost to procure or license the application, a cost to purchase or lease hardware on which the application will execute, costs to hire contractors to implement and configure the application, costs to train personnel on using the application, and other costs associated with implementing or configuring the application.

In some embodiments, an application proposal is generated by the solution proposal and estimate engine 204 as a function of received scoping question answers and the adaptation catalog entries associated with those answers. As discussed above, the rules associated with adaptation catalog entries may specify which portions of an application must be included or excluded. In some such embodiments, the included and excluded portion of the application are utilized by the solution proposal and estimate engine to generate the application proposal. If more than one application is available, the application meeting more of a customer's needs with preconfigured content is selected for the application proposal.

In some embodiments, the project roadmap is generated by the solution proposal and estimate engine 204 as a function of the adaptation catalog entries associated with the received scoping question answers. In some embodiments, the adaptation catalog entries, or another data structure associated with adaptation catalog entries, details tasks associated with implementing one or more portion of the application. For example, when an adaptation catalog entry rule requires inclusion of a portion of the application, one or more implementation tasks may be associated with that portion of the application. The details of a task may specify relationships between tasks that can be performed in parallel or that certain tasks must be completed before one or more other tasks. The solution proposal and estimate engine 204 may then stitch together identified tasks to build the project roadmap.

In some embodiments, the details of a task may further include an time estimate to complete the task. The time estimates of the various tasks included in the project roadmap may then be used to build a timeline that provides additional information to a customer, such as a time estimate of how long it will take to implement the application.

In some embodiments, the details of a task may further identify a role of a person to perform the task. The role, in some embodiments, identifies a contractor that will perform the task. The role information associated with the tasks of a project roadmap may then be used to build a list of required resources to execute the project roadmap.

In some embodiments, the application proposal and the project roadmap are further utilized by the solution proposal and estimate engine 204 to generate the cost estimate. The solution proposal and estimate engine 204, in some such embodiments, utilized information associated with adaptation catalog entries that identifies a cost of one or more portion of the application. The solution proposal and estimate engine may further obtain cost information associated with one or more hardware requirements of the application. Further, in building the cost estimate, the solution proposal and estimate engine may obtain role information from the project roadmap and a cost associated with the task and role information to determine a cost to obtain services of one or more contractors. These cost factors are then assembled to form the cost estimate.

In some embodiments, one or more of the application proposal, project roadmap, and cost estimate are generated upon receipt of the scoping question answers. One or more of the application proposal, project roadmap, and cost estimate may be provided for viewing on a computer screen, printed on paper, emailed, made available via a login on the Internet, or made available via another medium.

FIG. 2B is a block diagram of a system 210 according to an example embodiment. The system 210 includes the configuration scoping application 202 and the application configuration environment 102.

The configuration scoping application 202, in some embodiments, includes a deduction engine 212, and an adaptation catalog 214′. In this embodiment, the configuration scoping application 202 further typically includes a solution proposal and estimate engine 216, a data migration planner 218, and an input cache 220.

The application configuration environment 102, in some embodiments, includes an adaptation catalog 214, a content repository 222, and a configuration package repository 224. In some such embodiments, the application configuration environment further includes a scoping input database 226, a configuration workspace 118, and a deployment module 230.

The adaptation catalog 214 may include a representation of all of the solution capabilities of an application to be configured, and eventually executed. Each capability of an application to be configured is identified in an adaptation catalog 214 entry. The adaptation catalog 214 entries each may be identified as an area, package, topic, or option and may be organized in a hierarchy with a child identifying the parent. An example hierarchy is a “General Ledger” capability, which in some embodiments typically is a package having two topics, “cash based” and “accrual based” which may be two application capabilities within the “General Ledger” capability.

The adaptation catalog 214 entries may further include scoping questions directed toward obtaining scoping information to determine what areas, packages, topics, and options are relevant to the user's needs. Additionally, the adaptation catalog entries typically include rules, the application of which can require inclusion or exclusion, or specify default inclusion or exclusion, of certain other areas, packages, topics, and options. Thus, because the areas, packages, topics, and options correlate to application capabilities, the inclusion, exclusion, and defaulting specifies what capabilities will be enabled and disabled in the application when deployed.

In some embodiments, rules and entries in the adaptation catalog can be linked to a configuration package that exists in the configuration package repository 224 within the application configuration environment 102. A configuration package includes one or more configuration settings that enable or disable functionality of the application when deployed.

In one embodiment, rules are applied by the deduction engine 212 of the configuration scoping application 202. The configuration scoping application 202 typically presents a user interface that requests answers to questions that may be identified by the deduction engine 212 based on the adaptation catalog 214′. The adaptation catalog 214′ typically is a copy of the adaptation catalog 214 of the application configuration environment 102. When an answer is received by the configuration scoping application 202 through the user interface, the answer may be stored in the input cache 220 of the configuration scoping application 202. The deduction engine 212 then typically applies the rule associated with the adaptation catalog 214′ entry of the question asked to the received answer. Through the application of the rule, in view of answers already received and rules already applied, the deduction engine 212 may be configured to identify a next question to ask. The identified question typically is then presented to the user through the user interface. This process may be configured to continue until either all of the questions have been asked or the user is out of time, or the user otherwise chooses to stop. If questions remain that have not been answered, the process typically can be continued at a later time or rules may be configured to specify default areas, packages, topics, and options in order to supply enough information to allow deployment of the application in a functional form.

In some embodiments, the configuration scoping application 218 further includes a data migration planner 218. In such embodiments, one or more additional scoping questions typically can be asked. These additional scoping questions may be directed toward obtaining information from the user about legacy systems and how data is stored within them. In some embodiments, the questions simply ask what systems are currently in use. In other embodiments, the questions are more detailed to obtain information such as what type of database is a system utilizing and what type of customization has been made or custom systems developed. The data migration planner 218 typically uses the answers to these additional questions to propose a data migration plan to the new application.

In some embodiments, the configuration scoping application 202 includes a solution proposal and estimate engine 216. In some other embodiments, the solution proposal and estimate engine 216 is a stand-alone application that accesses data of the configuration scoping application 202 and from the application configuration environment. In some embodiments, the solution proposal and estimate engine 216 is the same as the solution proposal and estimate engine 204 illustrated in FIG. 2A.

In some embodiments, the solution proposal and estimate engine 216 may be used in a sales situation. For example, if a sales person is discussing with a sales lead what a certain application product can do for the sales lead, the sales person typically can utilize the configuration scoping application 202 to obtain information about the needs of the sales lead via the scoping questions. The scoping question answers may then be utilized by the solution proposal and estimate engine 216 to make an initial determination of what will be involved if the sales lead decides to purchase the application. The determination of what is involved if the sales lead decides to purchase the application is made as a function of one or more of the scoping question answers and adaptation catalog entries.

The solution proposal and estimate engine 216 typically is configured to output information for the sales person to make several determinations, such as the size of effort necessary to implement or transition to the application from legacy system, the cost involved, and cost. In some embodiments, the output of the solution proposal and estimate engine 216 outputs one or more of an implementation cost estimate, an application solution proposal, and a recommended project roadmap. In some embodiments, the solution proposal and estimate engine 216 outputs a proposal for one or more other options, application descriptions, sales literature, benefit statements of using the application, and additional documents, such as a proposal of key performance indicators the application can monitor to assist in managing the application or enterprise of the sales lead.

After the scoping question have been answered, the answers, and any other information obtained from a sales lead or other user of the configuration scoping application 202, the information typically is uploaded to the application configuration environment. However, in embodiments, where the configuration scoping application 202 executes on the same computing device as the application configuration environment 202, the scoping question answers and other information may be stored directly to the application configuration environment 102.

When the configuration question answers and other information is uploaded, or otherwise stored to the application environment 102, the scoping question answers are stored to the scoping input database 226. The scoping question answers, in some instances, will be referred to interchangeably as the “scoping information.”

After the scoping information is within the scoping input database 226, a typical process within the application configuration environment 102 can execute to begin configuring an application in the configuration workspace 228. The configuration workspace may include a set of configuration tables that mirrors, at least in part, the configuration tables of the application.

The process that configures the application typically determines one or more configuration packages to instantiate in the configuration workspace 228. Configuration packages, in some embodiments, include one or a set of configuration settings to enable or disable certain capabilities of the application. Configuration packages, as mentioned above, can be linked to adaptation catalog 214 entries and rules associated with adaptation catalog entries. Thus, the process that configures the application in the configuration workspace 228 typically queries the scoping information in the scoping input database 226 to identify configuration packages to instantiate.

In some embodiments, demonstration data exists to facilitate the instantiation of a demonstration instance of the application for a sales lead, training session, or other purpose. The demonstration data, in some embodiments, is linked to one or more configuration packages from the configuration package repository 224. The demonstration data typically exists in the content repository 222 so that it can be copied into a set of application tables in the configuration workspace 228. These tables may hold such data transactional data, operational data, master data, or other data that can exist in the application when the application is ready for execution or is executed.

Once the demonstration data is copied to the configuration workspace 228, that data may be fine-tuned to more closely match the intended use of the demonstration data. For example, the system may be configured to that a sales person, or other individual, can fine-tune demonstration data values to more closely match a sales lead's expectations of the application. Such fine tuning may include modifying sales order documents in the demonstration data to include a name, address, and logo of the sales lead's enterprise, or other similar modifications to the demonstration data.

After the application has been configured in the configuration workspace and the demonstration data, if any, is ready, the configuration typically is deployed by the deployment module 230. The deployment module 230 may be configured to deploy configuration settings to a baseline application that has already been instantiated in an application execution environment. In some embodiments, the deployment module includes a configuration setting deployment process, an activation process, and a data deployment process. The configuration setting deployment process typically copies configuration settings from configuration tables in the configuration workspace 228. The data deployment process may be configured to execute if there is demonstration data in the configuration workspace 228. If there is demonstration data, the data typically is copied from the configuration workspace 228 to application tables in the application execution environment. Some embodiments further utilize the activation process.

The activation process, in some of such embodiments, executes to activate the application in the application execution environment after it has been successfully deployed. In some instances, the activation process requires an activation key, message, code, or other authorization from an activation authority to activate the application. The activation authority may be configured to include one or more of a number of individuals or entities. An example of an activation authority is an entity selling the application to be activated. This activation functionality requiring an activation key or other mechanism can be utilized for several purposes. Some of such purposes typically include allowing the entity selling the application to ensure the application is properly configured, has passed certain testing necessary for the entity to ensure it will meet guaranteed service level agreements or objectives, for billing purposes, or other purposes that can benefit from such an activation process.

In some embodiments, the deployment module 230 further includes a delta deployment process that is relevant only after an application has already been deployed. When an application is deployed, or subsequently modified, the scoping information in the scoping input database 226 typically is updated. In some embodiments, enables tracking of a current configuration of a deployed application. In embodiments including the delta deployment process, the scoping information typically is further tracked on a historical basis to at least allow a view of a current configuration and a modified configuration not yet deployed, if applicable. The delta deployment process then typically uses that historical tracking of the application configuration to identify changes between the current application configuration and the modified configuration not yet deployed. The delta deployment process then normally only deploys the changes to the application configuration.

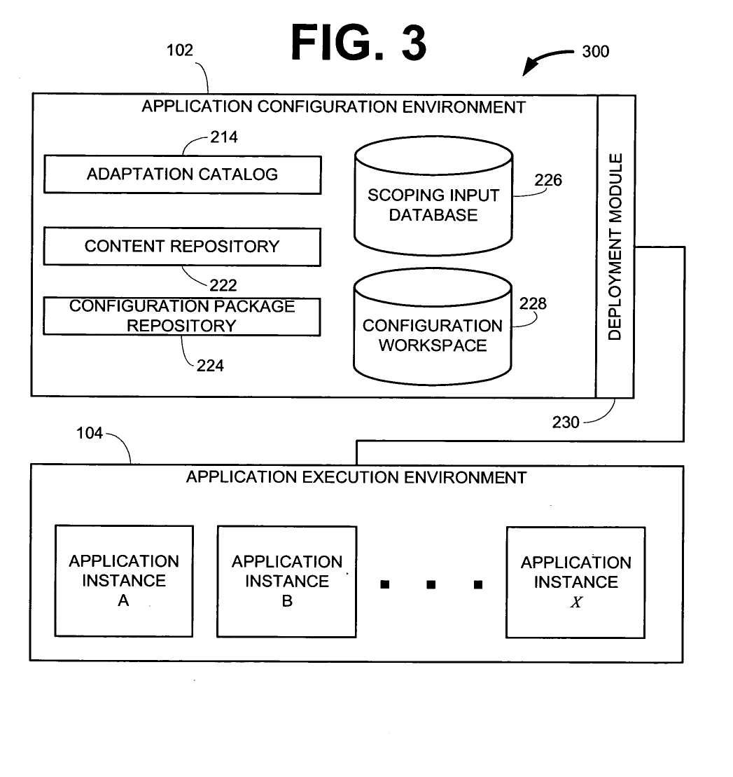

FIG. 3 is a block diagram of a system 300 according to an example embodiment. The system 300 includes the application configuration environment 102 as discussed above with regard to FIG. 1, FIG. 2A, and FIG. 2B. The system 300 further includes an application execution environment 104.

The application execution environment 104 is a data processing environment within which an application, or an application to be deployed, can execute. When deploying an application, the deployment module 230 needs to know what application execution environment 104 and what application instance within that environment to deploy to. In embodiments including only one application execution environment 104, the application execution environment 104 may already be known. Similarly, in an application execution environment including only a single application instance, the instance may already be known.

Each instance of the application (i.e., application instances A, B, . . . X) typically includes a set of identical configuration tables which can include distinct configuration settings from one another. In some embodiments, multiple instances of the application exist to provide a development instance, a test instance, and a production instance. In such embodiments where there are multiple application instances, the deployment module 230 may be configured to deploy the configuration settings from one of the application instances in the application execution environment 104 to another application in the same or another application execution environment 104. Although the deployment module 230 is illustrated as being a part of the application configuration environment 102, the deployment module 230, in other embodiments, can be a standalone application or a part of another application or process.

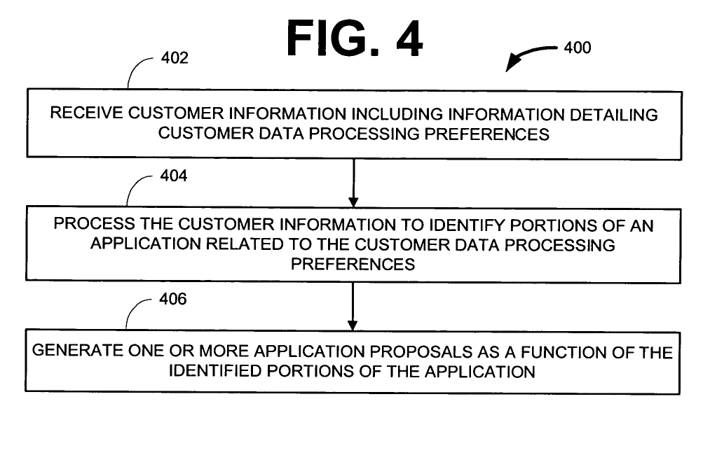

FIG. 4 is a flow diagram of a method 400 according to an example embodiment. In some embodiments, the example method 400 includes receiving customer information including information detailing customer data processing preferences 402 and processing the customer information to identify portions of an application related to the customer data processing preferences 404. The method 400 also typically includes generating one or more application proposals as a function of the identified portions of the application 406.

In some such embodiments of the method 400, the customer data processing preferences include one or more data processing requirements.

The one or more application proposals may include an application solution proposal that meets at least some of the customer data processing preferences. The one or more application solution proposals may include not only a proposed application, but also a proposed configuration of the proposed application.

An application solution proposal may further include a project plan for implementing and configuring the proposed application. Some embodiments include preconfigured application content in the application solution proposal selected as a function of the received customer information.

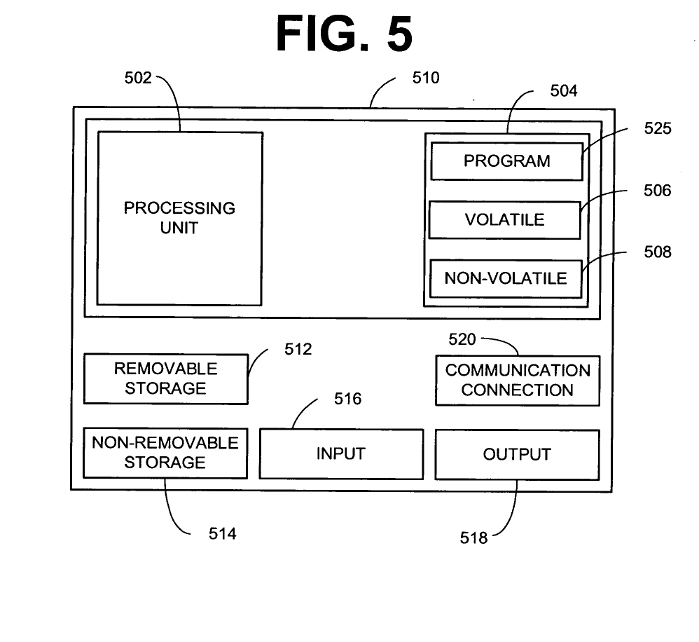

FIG. 5 is a block diagram of a computing system according to an example embodiment. In one embodiment, multiple such computer systems are utilized in a distributed network to implement multiple components in a transaction-based environment. An object-oriented architecture may be used to implement such functions and communicate between the multiple systems and components. One example computing device in the form of a computer 510, may include a processing unit 502, memory 504, removable storage 512, and non-removable storage 514. Memory 504 may include volatile memory 506 and non-volatile memory 508. Computer 510 may include—or have access to a computing environment that includes—a variety of computer-readable media, such as volatile memory 506 and non-volatile memory 508, removable storage 512 and non-removable storage 514. Computer storage typically includes random access memory (RAM), read only memory (ROM), erasable programmable read-only memory (EPROM) & electrically erasable programmable read-only memory (EEPROM), flash memory or other memory technologies, compact disc read-only memory (CD ROM), Digital Versatile Disks (DVD) or other optical disk storage, magnetic cassettes, magnetic tape, magnetic disk storage or other magnetic storage devices, or any other medium capable of storing computer-readable instructions. Computer 510 may include or have access to a computing environment that includes input 516, output 518, and a communication connection 520. The computer may operate in a networked environment using a communication connection to connect to one or more remote computers, such as database servers. The remote computer may include a personal computer (PC), server, router, network PC, a peer device or other common network node, or the like. The communication connection may include a Local Area Network (LAN), a Wide Area Network (WAN) or other networks.

Computer-readable instructions stored on a computer-readable medium are executable by the processing unit 502 of the computer 510. A hard drive, CD-ROM, and RAM are some examples of articles including a computer-readable medium. The term “computer readable medium” is also used to represent carrier waves on which the software is transmitted. For example, a computer program 525 capable of providing a generic technique to perform access control check for data access and/or for doing an operation on one of the servers in a component object model (COM) based system according to the teachings of the present invention may be included on a CD-ROM and loaded from the CD-ROM to a hard drive. The computer-readable instructions allow computer 510 to provide generic access controls in a COM based computer network system having multiple users and servers.

It is emphasized that the Abstract is provided to comply with 37 C.F.R. § 1.72(b) requiring an Abstract that will allow the reader to quickly ascertain the nature and gist of the technical disclosure. It is submitted with the understanding that it will not be used to interpret or limit the scope or meaning of the claims.

In the foregoing Detailed Description, various features are grouped together in a single embodiment to streamline the disclosure. This method of disclosure is not to be interpreted as reflecting an intention that the claimed embodiments of the invention require more features than are expressly recited in each claim. Rather, as the following claims reflect, inventive subject matter lies in less than all features of a single disclosed embodiment. Thus, the following claims are hereby incorporated into the Detailed Description, with each claim standing on its own as a separate embodiment.

It will be readily understood to those skilled in the art that various other changes in the details, material, and arrangements of the parts and method stages which have been described and illustrated in order to explain the nature of this invention may be made without departing from the principles and scope of the invention as expressed in the subjoined claims.

What is claimed is:

1. A system comprising:
a customer profiling application, wherein the customer profiling application receives and stores customer information including information detailing customer data processing preferences; and
a solution proposal and estimate engine, wherein the solution proposal and estimate engine processes the customer information to produce output including one or more application proposals.

2. The system of claim 1, wherein the customer data processing preferences include one or more data processing requirements.

3. The system of claim 1, wherein the one or more application proposals include an application solution proposal that meets at least some of the customer data processing preferences.

4. The system of claim 3, wherein the application solution proposal includes a proposed application and a configuration for the proposed application.

5. The system of claim 4, wherein the one or more application solution proposals further include a project plan for implementing and configuring the proposed application.

6. The system of claim 4, wherein the application solution proposal further includes preconfigured application content selected as a function of the received customer information.

7. The system of claim 3, wherein the one or more solution proposals further include a cost estimate for the application solution proposal.

8. A method comprising:
receiving customer information including information detailing customer data processing preferences;
processing the customer information to identify portions of an application related to the customer data processing preferences; and
generating one or more application proposals as a function of the identified portions of the application.

9. The method of claim 8, wherein the customer data processing preferences include one or more data processing requirements.

10. The method of claim 8, wherein the one or more application proposals include an application solution proposal that meets at least some of the customer data processing preferences.

11. The method of claim 10, wherein the application solution proposal includes a proposed application and a configuration for the proposed application.

12. The method of claim 11, wherein the one or more application solution proposals further include a project plan for implementing and configuring the proposed application.

13. The method of claim 11, wherein the application solution proposal further includes preconfigured application content selected as a function of the received customer information.

14. The method of claim 10, wherein the one or more solution proposals further include a cost estimate for the application solution proposal.

15. A machine-readable medium, with encoded instructions, which when executed, cause a machine to:
receive customer information including information detailing customer data processing preferences;
process the customer information to identify portions of an application related to the customer data processing preferences; and
generate one or more application proposals as a function of the identified portions of the application.

16. The machine-readable medium of claim 15, wherein the one or more application proposals include an application solution proposal that meets at least some of the customer data processing preferences.

17. The machine-readable medium of claim 17, wherein the application solution proposal includes a proposed application and a configuration for the proposed application.

18. The machine-readable medium of claim 18, wherein the one or more application solution proposals further include a project plan for implementing and configuring the proposed application.

19. The machine-readable medium of claim 18, wherein the application solution proposal further includes preconfigured application content selected as a function of the received customer information.

20. The machine-readable medium of claim 17, wherein the one or more solution proposals further include a cost estimate for the application solution proposal.
